(19) United States
(12) Patent Application Publication
(10) Pub. No.: US 2025/0138557 A1
(43) Pub. Date: May 1, 2025

(54) MOVING BODY AND MOVING BODY SYSTEM

(71) Applicant: Panasonic Intellectual Property Management Co., Ltd., Osaka (JP)

(72) Inventor: TAKAYUKI NAGATA, Osaka (JP)

(21) Appl. No.: 19/000,807

(22) Filed: Dec. 24, 2024

Related U.S. Application Data
(63) Continuation of application No. PCT/JP2023/024832, filed on Jul. 4, 2023.

(30) Foreign Application Priority Data
Jul. 15, 2022 (JP) 2022-113811

(51) Int. Cl. G05D 1/695; G05D 1/65; G05D 1/698; G05D 111/30

(52) U.S. Cl. CPC G05D 1/695; G05D 1/65; G05D 1/6985; G05D 2111/30

(57) ABSTRACT

A moving body that follows a preceding moving body includes a position calculator that identifies a position of the preceding moving body based on an output value from a sensor that acquires information around the moving body, a receiver that receives displacement information indicating a displacement amount of a position of the preceding moving body due to movement of the preceding moving body, and an operation controller that performs control to move the moving body based on an identified position of the preceding moving body and the displacement information in a state of losing sight in which the position calculator cannot identify a position of the preceding moving body.

### TECHNICAL FIELD

The present invention relates to a moving body and a moving body system including a preceding moving body and a moving body that moves following the preceding moving body.

### BACKGROUND ART

In a moving body that moves following a preceding moving body, a method for accurately detecting a position and a direction of the preceding moving body has been proposed.

PTL 1 describes a technique in which a following robot detects at least two reflective targets provided on a preceding moving body by using a range sensor, and recognizes a relative position and direction of the preceding moving body as viewed from the following moving body based on a detection result. This range sensor emits an electromagnetic wave such as laser, for example, and detects a distance and a direction to a surrounding component by a reflected wave from the surrounding component, and is configured to scan a scanning plane by using an electromagnetic wave.

According to the technique disclosed in PTL 1, a following robot can accurately grasp a path through which a preceding moving body passes and move along the path. Further, a reflective target is also mounted on the following robot, and the following robot is caused to further follow another following robot, so that it is possible to cause a plurality of moving robots to move in formation.

### CITATION LIST

### Patent Literature

PTL 1: Unexamined Japanese Patent Publication No. 2019-220143

### SUMMARY OF THE INVENTION

However, in the method of recognizing a preceding moving body disclosed in PTL 1, in a case where an object such as a human enters a space between a preceding moving body and a following robot, a situation in which the following robot cannot detect the preceding moving body may occur. When such a situation occurs, the following robot cannot grasp a path of the preceding moving body, and the following robot cannot move following the preceding moving body. Accordingly, a distance between the preceding moving body and the following robot becomes long. After the above, even if the situation in which the object enters a space between the following robot and the preceding moving body is resolved, it is difficult for the following robot to automatically find the preceding moving body and resume following travel.

In view of such circumstances, an object of the present disclosure is to provide a moving body and a moving body system in which a following moving body automatically finds a preceding moving body and resumes following travel even when a situation in which the following moving body cannot detect the preceding moving body occurs.

In order to achieve the above object, a moving body according to one aspect of the present disclosure is a moving body that follows a preceding moving body, and includes a position calculator that specifies a position of the preceding moving body based on an output value from a sensor that acquires information around the moving body, a receiver that receives displacement information indicating a displacement amount of a position of the preceding moving body due to movement of the preceding moving body, and an operation controller that performs control to move the moving body based on an identified position of the preceding moving body and the displacement information in a state of losing sight where the position calculator cannot identify a position of the preceding moving body.

A moving body system according to one aspect of the present disclosure includes a preceding first moving body and a second moving body that follows the first moving body. The first moving body transmits displacement information indicating a displacement amount of a position of the first moving body per unit time to the second moving body. The second moving body includes a position calculator that identifies a position of the first moving body based on an output value from a sensor that acquires information around the second moving body, a receiver that receives the displacement information from the first moving body, and an operation controller that performs control to move the first moving body based on an identified position of the first moving body and the displacement information in a state of losing sight in which the position calculator cannot identify a position of the first moving body.

According to the present disclosure, even when a situation in which a following moving body cannot identify a preceding moving body occurs, the following moving body can automatically find the preceding moving body and resume following traveling.

### BRIEF DESCRIPTION OF THE DRAWINGS

FIG. 1 is a diagram for explaining a moving body system according to the present exemplary embodiment.

FIG. 2 is a diagram for explaining a configuration of a first moving body.

FIG. 3 is a functional block diagram of a controller of a first moving body.

FIG. 4 is a diagram for explaining a configuration of a second moving body.

FIG. 5 is a diagram illustrating a state in which a reflector of the preceding first moving body is detected by a detector of the second moving body.

FIG. 6 illustrates a functional block diagram of the controller of the second moving body.

FIG. 7 is a diagram for explaining a method of calculating a detected position by a position calculator.

FIG. 8 is a diagram for explaining a method of setting a target point.

FIG. 9 is a diagram for explaining a method of setting a target point.

FIG. 10 is a flowchart illustrating an example of operation of the first moving body.

FIG. 11 is a flowchart illustrating an example of operation of the second moving body.

FIG. 12 is a flowchart illustrating an example of an operation at the time of losing sight by the second moving body.

### DESCRIPTION OF EMBODIMENT

Hereinafter, an exemplary embodiment of the present disclosure will be described with reference to the drawings. Note that the same constituent elements are denoted by the same reference sign. Further, the drawings are schematically illustrated mainly for each constituent element for easy understanding.

### <Overall Configuration of Moving Body System 1>

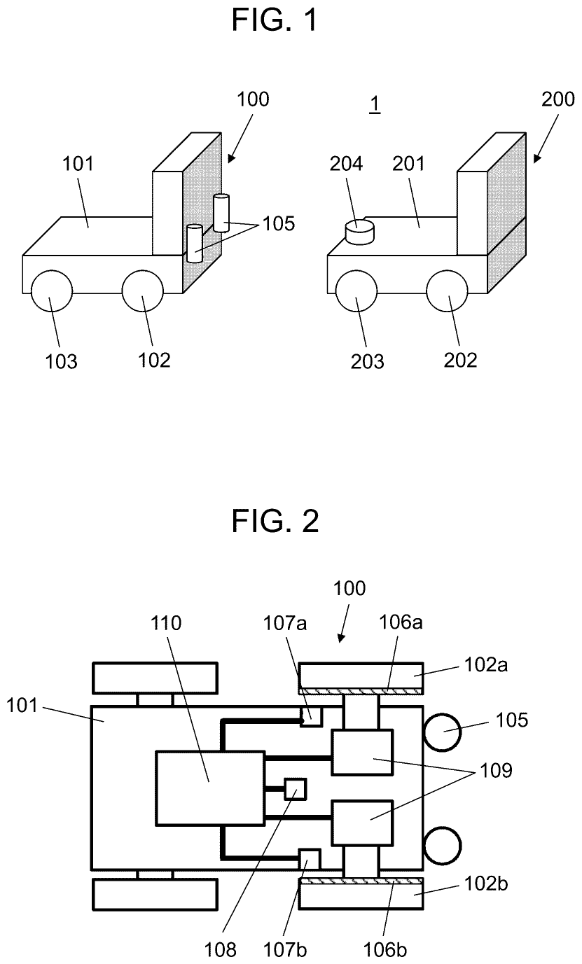

FIG. 1 is a diagram for explaining moving body system 1 according to the present exemplary embodiment. As illustrated in FIG. 1, moving body system 1 includes first moving body 100 and second moving body 200.

First moving body 100 is a moving body that moves based on operation of an operator. Second moving body 200 is a moving body that automatically follows a track along which first moving body 100 moves.

### [First Moving Body 100]

As illustrated in FIG. 1, first moving body 100 includes main body 101, a pair of wheels 102, a pair of trailing wheels 103, and at least two reflectors 105. In description below, a forward direction of first moving body 100 and second moving body 200 is a direction in which first moving body 100 and second moving body 200 move. Further, a vertical direction of first moving body 100 and second moving body 200 is a vertical direction in a case where first moving body 100 and second moving body 200 are placed on a horizontal road surface.

Main body 101 is a portion on which each component of first moving body 100 is mounted. For example, in a case where first moving body 100 is a wheelchair, main body 101 includes a base, a seat surface, a handrail, a step, a backrest, and the like.

The pair of wheels 102 are wheels that are installed at a lower portion of main body 101 and move first moving body 100 by transmitting driving force applied from drive unit 109 to a road surface. The pair of wheels 102 are configured to be independently driven. That is, for example, while one wheel 102 is rotated forward, another wheel 102 can be rotated backward. By the above, first moving body 100 can perform not only straight traveling and backward traveling but also various types of movement such as right turning and left turning.

The pair of trailing wheels 103 are installed at a lower portion of main body 101. As wheel 102 and trailing wheel 103, for example, a caster, an omni wheel, or the like is used.

Reflector 105 is attached to a back surface of main body 101 along the vertical direction of main body 101, and efficiently reflects an electromagnetic wave emitted from second moving body 200 for detecting a position of first moving body 100. In the present exemplary embodiment, two reflectors 105 are symmetrically attached to a back surface of main body 101. Note that a back surface of main body 101 means a surface opposite to a straight traveling direction of first moving body 100. In other words, the back surface of main body 101 is a surface of main body 101 close to second moving body 200 when second moving body 200 moves following first moving body 100.

In the present exemplary embodiment, each of two reflectors 105 is formed in a cylindrical shape. A side surface of reflector 105 having a cylindrical shape is a reflection surface that can efficiently reflect an electromagnetic wave emitted from second moving body 200. Note that a shape of reflector 105 is not limited to a cylindrical shape, and only needs to be what is called a rotating body (a three-dimensional figure obtained by rotating a straight line or a curve in a certain plane around a straight line in the same plane as an axis of rotation), but a shape of a side surface is desirably a shape that can efficiently reflect an electromagnetic wave.

FIG. 2 is a diagram for explaining a configuration of first moving body 100. FIG. 2 illustrates a state in which first moving body 100 is viewed from above. As illustrated in FIG. 2, sensing rings 106a and 106b are provided inside a pair of wheels 102a and 102b, respectively. Sensing rings 106a, 106b have a configuration in which, for example, a design (stripe pattern) in which black and white patterns are alternately arranged is arranged on a surface. Encoders 107a, 107b are provided at positions facing sensing rings 106a, 106b in main body 101 of first moving body 100. When wheels 102a, 102b rotate, encoders 107a, 107b detect a white region or a black region of a black-and-white pattern of sensing rings 106a, 106b passing in front of encoders 107a, 107b, respectively, and generate a pulse signal.

Gyro 108 detects an angle change of first moving body 100 in a plane on which first moving body 100 is installed and generates an angle detection signal.

Drive unit 109 is, for example, a motor, and provides driving force for moving first moving body 100 with respect to wheel 102. Controller 110 controls operation of drive unit 109.

Controller 110 is a computer that controls each component of first moving body 100. Controller 110 is a processor including a central processing unit (CPU), a read only memory (ROM), and a random access memory (RAM), for example. Controller 110 reads out a program stored in the ROM, loads the program into the RAM, and controls each component of first moving body 100 according to the loaded program. The RAM forms a work area in which various programs to be executed by the CPU and data related to the programs are temporarily stored. The ROM is composed of a nonvolatile memory and the like, and stores various programs and various data that are to be used for control. Note that controller 110 may be mounted inside main body 101, or may be provided outside first moving body 100 and remotely operate each configuration of first moving body 100 via a communication network or the like.

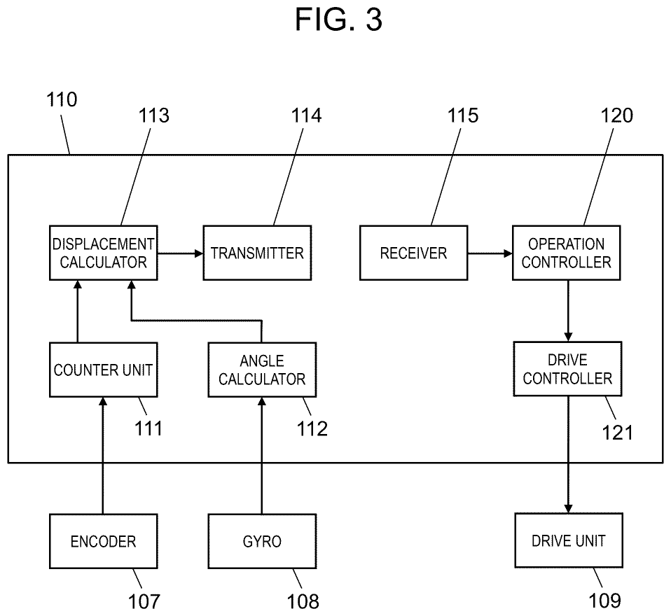

FIG. 3 is a functional block diagram of controller 110 of first moving body 100. As illustrated in FIG. 3, controller 110 includes counter unit 111, angle calculator 112, displacement calculator 113, transmitter 114, receiver 115, operation controller 120, and drive controller 121.

Counter unit 111 counts the number of pulses (the number of times that a white region or a black region of a black-and-white pattern of sensing rings 106a, 106b passes through the front of encoders 107a, 107b) based on a pulse signal acquired from encoders 107a, 107b.

Angle calculator 112 calculates a traveling direction of first moving body 100 based on an angle detection signal acquired from gyro 108.

Displacement calculator 113 calculates displacement information indicating a moving amount and a moving direction of first moving body 100 per unit time based on a counting result acquired from counter unit 111 and a traveling direction acquired from angle calculator 112. In the present exemplary embodiment, since the displacement information is information obtained by encoder 107 measuring a rotation amount of wheels 102a, 102b, it can also be referred to as odometry information.

Transmitter 114 transmits displacement information calculated by displacement calculator 113 to second moving body 200. Transmitter 114 may transmit the displacement information by, for example, wireless communication.

Receiver 115 receives various types of information from second moving body 200 that follows first moving body 100 and operation information from an operator who performs remote operation of first moving body 100. The various types of information from second moving body 200 include stop request information for requesting first moving body 100 to stop, start request information for requesting first moving body 100 to start (resume) moving, or the like. The operation information from an operator is transmitted from, for example, an external controller that generates and transmits the operation information based on operation of the operator.

Operation controller 120 gives a command to drive controller 121 so as to move first moving body 100 according to the operation information. Drive controller 121 controls drive unit 109 such as a motor so as to rotate wheels 102a, 102b in a desired rotation direction and rotation speed according to a command of operation controller 120.

By the above, first moving body 100 moves according to operation of an operator. Note that in a case where an object is detected in front of an own moving body by an object sensor (not illustrated) or the like, operation controller 120 stops movement according to operation information until the object is no longer detected. By the above, it is possible to prevent a situation such as collision of first moving body 100 with an object. While movement is stopped, first moving body 100 may transmit a message indicating that movement is stopped due to an obstacle to a controller or the like of an operator.

Note that in the above description, the case where an operator operates first moving body 100 by remote operation is described. However, for example, an operator may directly get on first moving body 100 and operate an operation unit provided in first moving body 100 so that the operator directly operates first moving body 100.

### [Second Moving Body 200]

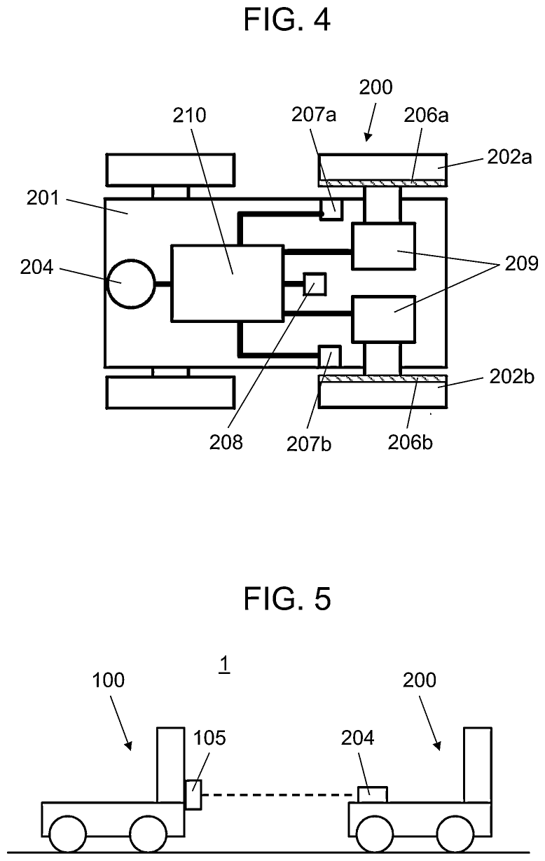

As illustrated in FIG. 1, second moving body 200 includes main body 201, a pair of wheels 202, a pair of trailing wheels 203, and sensor 204. Further, as illustrated in FIG. 4, second moving body 200 includes sensing rings 206a, 206b, encoders 207a, 207b, drive unit 209, and controller 210. FIG. 4 is a diagram for explaining a configuration of second moving body 200.

Main body 201 is a portion on which each component of second moving body 200 is mounted. For example, in a case where second moving body 200 is a wheelchair, main body 201 includes a base, a seat surface, a handrail, a step, a backrest, and the like.

The pair of wheels 202a,202b are wheels that are installed at a lower portion of main body 201 and move second moving body 200 by transmitting driving force applied from drive unit 209 to a road surface. Similarly to wheel 102, the pair of wheels 202 are configured to be independently driven.

The pair of trailing wheels 203 are installed at a lower portion of main body 201. As wheels 202a, 202b and railing wheel 203, for example, a caster, an omni wheel, or the like is used.

Sensor 204 scans the inside of a scanning plane by using sensors that emit an electromagnetic wave such as laser, infrared rays, and millimeter waves. Then, sensor 204 detects a distance and a direction of an object present in the scanning plane as viewed from second moving body 200 based on a reflected wave from the object present around second moving body 200. A detection result of sensor 204 is output to controller 210. A scanning plane of sensor 204 is configured to be substantially horizontal when second moving body 200 is located on a horizontal road surface.

FIG. 5 is a diagram illustrating how sensor 204 of second moving body 200 detects reflector 105 of preceding first moving body 100. A road surface illustrated in FIG. 5 is a horizontal plane. In the example illustrated in FIG. 5, a scanning plane of sensor 204 is parallel to a road surface, that is, horizontal.

As illustrated in FIG. 5, when both first moving body 100 and second moving body 200 are on the same plane, a scanning plane of sensor 204 is configured such that height in the vertical direction is substantially the same as that of reflector 105 of first moving body 100. By the above, an electromagnetic wave emitted by sensor 204 is well reflected by reflector 105, and sensor 204 can receive a reflected wave by reflector 105. That is, reflector 105 can be accurately detected by sensor 204. Examples of a sensor used by sensor 204 include a laser range finder.

In a case of being able to detect reflector 105 of first moving body 100, sensor 204 outputs a detection signal including a direction in which first moving body 100 exists and a distance to first moving body 100.

Drive unit 209 is, for example, a motor, and provides driving force for moving second moving body 200 with respect to wheel 202. Controller 210 controls operation of drive unit 209.

Controller 210 is a computer that controls each component of second moving body 200. Controller 210 is a processor including a CPU, a ROM, and a RAM, for example, like controller 110. Controller 210 reads out a program stored in the ROM, loads the program into the RAM, and controls each component of second moving body 200 according to the loaded program. The RAM forms a work area in which various programs to be executed by the CPU and data related to the programs are temporarily stored. The ROM is composed of a nonvolatile memory and the like, and stores various programs and various data that are to be used for control. Note that controller 210 may be mounted inside main body 201, or may be provided outside second moving body 200 and remotely operate each configuration of second moving body 200 via a communication network or the like.

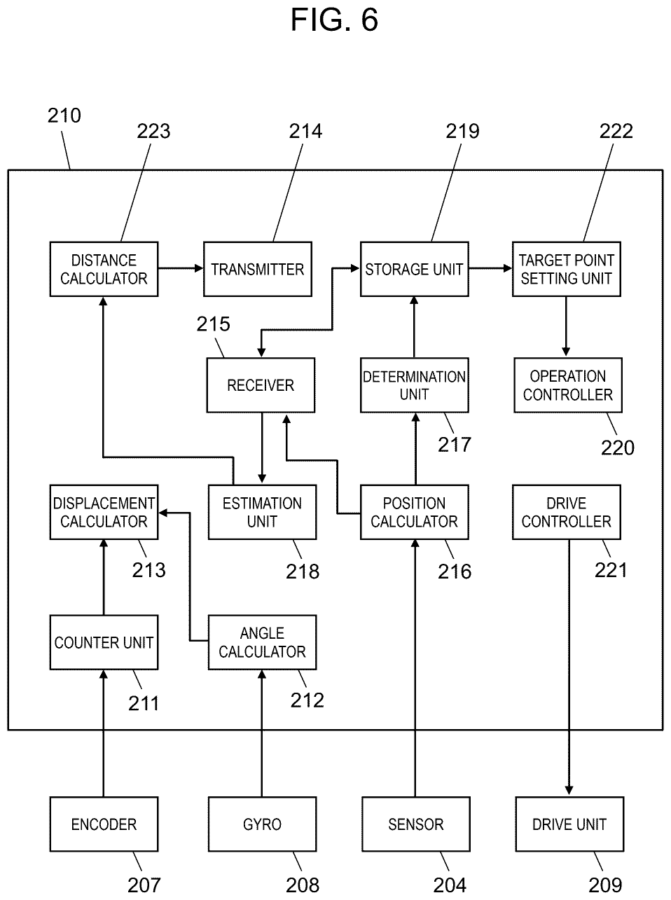

FIG. 6 is a functional block diagram of controller 210 of second moving body 200. As illustrated in FIG. 6, controller 210 includes counter unit 211, angle calculator 212, displacement calculator 213, transmitter 214, receiver 215, position calculator 216, determination unit 217, storage unit 219, operation controller 220, drive controller 221, target point setting unit 222, and distance calculator 223.

Counter unit 211 counts the number of pulses (the number of times that a white region or a black region of a black-and-white pattern of sensing rings 206a, 206b passes through the front of encoders 207a, 207b) based on a pulse signal acquired from encoders 207a, 207b.

Angle calculator 212 calculates a traveling direction of second moving body 200 based on an angle detection signal acquired from gyro 208.

Displacement calculator 213 calculates displacement information indicating a moving amount and a moving direction of second moving body 200 per unit time based on a counting result acquired from counter unit 211 and a traveling direction acquired from angle calculator 212. In the present exemplary embodiment, since the displacement information is information obtained by encoder 207 measuring a rotation amount of wheels 202a, 202b, it can also be referred to as odometry information.

Transmitter 214 transmits displacement information calculated by displacement calculator 213 to another moving body. Transmitter 214 may transmit the displacement information by, for example, wireless communication.

Receiver 215 receives various types of information from first moving body 100. The various types of information received from first moving body 100 are, for example, displacement information of preceding first moving body 100.

Position calculator 216 calculates a detected position of first moving body 100 based on a detection signal from sensor 204. The detected position is a position where second moving body 200 detects first moving body 100 at a certain time point. Details of a method of calculating the detected position by position calculator 216 will be described later. Position calculator 216 outputs a result of the calculation as detected position information.

Determination unit 217 determines whether position calculator 216 correctly identifies a position (direction and distance) of first moving body 100. In a case where sensor 204 cannot detect a position of first moving body 100, determination unit 217 determines that sight of first moving body 100 is lost. In description below, a state in which sensor 204 cannot detect a position of first moving body 100 and second moving body 200 loses sight of first moving body 100 will be referred to as a state of losing sight. The state of losing sight may occur, for example, when an object such as a person enters a space between first moving body 100 and second moving body 200.

In a case where determination unit 217 determines that first moving body 100 is in the state of losing sight, estimation unit 218 estimates a position of first moving body 100 at a current time point based on detected position information that can be last identified (immediately before the state of losing sight is established) and displacement information of first moving body 100 from the state of losing sight to the current time point. Note that the displacement information of first moving body 100 from the state of losing sight to the current time point is, in other words, displacement information from a last time point when the position can be identified to current time point. Estimation unit 218 outputs estimated position information indicating an estimated position of first moving body 100.

Storage unit 219 stores displacement information of first moving body 100 acquired from receiver 215, detected position information of first moving body 100 acquired from position calculator 216, and estimated position information acquired from estimation unit 218 in chronological order. As a result, information regarding a point where first moving body 100 moves as viewed from second moving body 200, that is, a track is accumulated in storage unit 219.

Target point setting unit 222 sets a target point to which second moving body 200 should go based on the estimated position information acquired from estimation unit 218 as necessary in addition to displacement information of second moving body 200 acquired from displacement calculator 213 and detected position information acquired from the position calculator. Then, target point setting unit 222 generates and outputs path information indicating a path to the set target point.

In a case where the state of losing sight is not established, target point setting unit 222 sets, as a target point, a detected position closest to a current position of second moving body 200 (position where first moving body 100 has passed in the past) based on displacement information and detected position information of second moving body 200.

Further, in a case where the state of losing sight is established, target point setting unit 222 sets one of a detected position or an estimated position closest to a current position of second moving body 200 as a target point based on displacement information, detected position information, and estimated position information of second moving body 200. Details of a method of setting a target point will be described later. Target point setting unit 222 generates and outputs target point information indicating a position of a target point.

Distance calculator 223 calculates a distance (hereinafter, an inter-vehicle distance) between first moving body 100 and second moving body 200 at a current time point based on displacement information of second moving body 200 acquired from displacement calculator 213, detected position information acquired from the position calculator, or estimated position information acquired from estimation unit 218. Then, in a case where the inter-vehicle distance is a predetermined threshold or more, distance calculator 223 generates stop request information for stopping movement of first moving body 100. The stop request information is transmitted to first moving body 100 by transmitter 214.

Operation controller 220 gives a command to drive controller 221 so as to move second moving body 200 toward a target point indicated by target point information. Specifically, operation controller 220 gives a command to drive controller 221 to move an own moving body toward a target point. Further, when determination unit 217 determines that an own moving body is in the state of losing sight, operation controller 220 gives a command to drive controller 221 so as to reduce a speed at which the own moving body is moved.

Drive controller 221 controls drive unit 209 such as a motor so as to rotate wheels 202a, 202b in a desired rotation direction and rotation speed according to a command of operation controller 220.

Note that in a case where an object is detected between an own moving body and a target point by sensor 204 or the like, operation controller 220 stops moving toward the target point until the object is no longer detected. By the above, it is possible to prevent a situation such as collision of second moving body 200 with an object.

### (Method of Calculating Detected Position by Position Calculator 216)

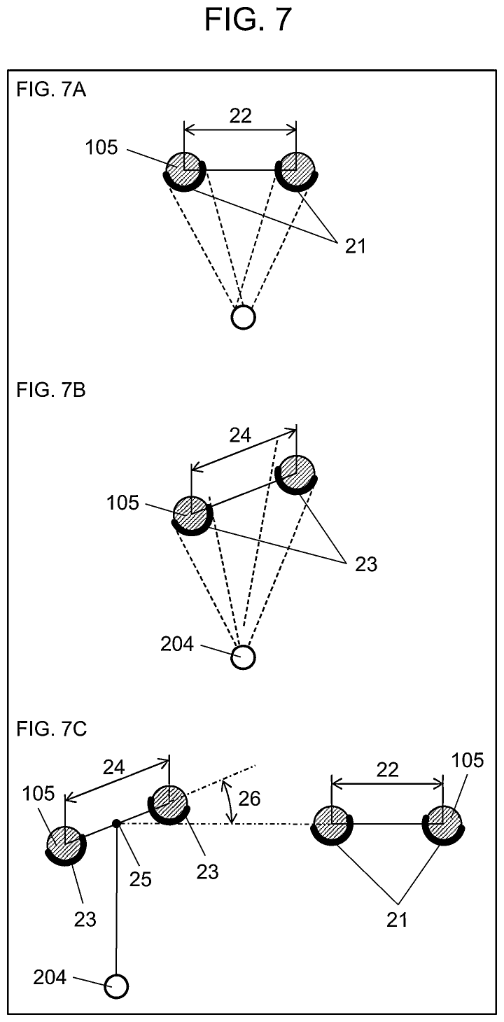

A method of calculating a detected position by position calculator 216 will be described with reference to FIG. 7.

First, position calculator 216 generates reference information based on a detection signal of reflector 105 by sensor 204 when first moving body 100 is at a determined position with respect to second moving body 200. The determined position is, for example, a position away by a determined distance in the front direction of second moving body 200. The determined distance is, for example, a distance determined in advance by an administrator or the like of moving body system 1.

FIG. 7A is a diagram for explaining reference shape 21 of reflector 105 in a scanning plane of sensor 204. FIG. 7A illustrates a top view of sensor 204 and reflector 105 in a scanning plane.

Reference shape 21 is a shape of a reflection surface of reflector 105 as viewed from sensor 204 in a scanning plane. Reference shape 21 is a shape of a portion of reflector 105 that reflects an electromagnetic wave emitted by sensor 204 located rearward. Since a cross-sectional shape of a scanning plane of reflector 105 is circular, reference shape 21 has a substantially semicircular shape as illustrated in FIG. 5A. Reference shape 21 is formed by position calculator 216 plotting a plurality of points corresponding to a position of a reflection surface of reflector 105 in a scanning plane based on a detection signal of sensor 204 and joining these points.

Note that, as a method of identifying a reflected wave by reflector 105 from among a plurality of reflected waves received by sensor 204, for example, there is a method of using a reflected wave having intensity equal to or more than a threshold as a reflected wave from reflector 105. In the present exemplary embodiment, since reflection efficiency of an electromagnetic wave by reflector 105 is larger than that of a general substance, such a method can be employed.

Furthermore, position calculator 216 calculates reference distance 22 based on a distance and a direction from sensor 204 to two reflectors 105. As illustrated in FIG. 7A, reference distance 22 is a two-dimensional distance between two reflectors 105 in a scanning plane. Position calculator 216 stores reference information including reference shape 21 and reference distance 22 in storage unit 219.

Note that generation of reference information may be performed, for example, when second moving body 200 is actually traveling following first moving body 100, or may be performed in a state where both first moving body 100 and second moving body 200 are stopped before start of following traveling. However, at the time of generation of reference information, positions of first moving body 100 and second moving body 200 need to be at predetermined relative positions.

While second moving body 200 actually travels by following first moving body 100, position calculator 216 acquires a shape of reflector 105 in a scanning plane again based on a detection signal, and determines whether or not the shape coincides with reference shape 21 included in reference information. FIG. 7B is a diagram for explaining detected shape 23 detected in a scanning plane. In FIG. 7B, as first moving body 100 and second moving body 200 move, a positional relationship between first moving body 100 and second moving body 200 changes from a positional relationship at the time of generation of reference information (see FIG. 7A). Note that even if a positional relationship between first moving body 100 and second moving body 200 changes, a cross-sectional shape of reflector 105 is circular, and an inter-vehicle distance between first moving body 100 and second moving body 200 is kept constant as described later, and for this reason, as long as reflector 105 exists in a scanning plane and an electromagnetic wave or a reflected wave is not blocked by an obstacle, second moving body 200 can always detect detected shape 23 having a shape that coincides with reference shape 21.

Then, position calculator 216 calculates detected distance 24, which is a distance in a scanning plane between two detected shapes 23 corresponding to two reflectors 105, and compares the detected distance with reference distance 22. Note that similarly to reference distance 22, second moving body 200 only needs to detect a distance and a direction from sensor 204 to two reflectors 105 by using a detection signal of sensor 204 and calculate detected distance 24 based on the distance and the direction.

Note that a difference between detected distance 24 calculated by position calculator 216 and reference distance 22 is within a certain error range, it is considered that reflector 105 is correctly detected. For this reason, when a difference between detected distance 24 and reference distance 22 is within a certain error range, determination unit 217 determines that a position of first moving body 100 is correctly identified. On the other hand, in a case where the difference is out of the error range, determination unit 217 determines that a position of first moving body 100 cannot be correctly identified. Here, the certain error range can be optionally set, and is, for example, a range within plus or minus 20% with respect to reference distance 22.

Next, position calculator 216 calculates a position and a direction of first moving body 100 at a current time point. Specifically, position calculator 216 sets a position of a midpoint between two detected shapes 23 corresponding to two reflectors 105 as a position (detected position 25) of first moving body 100 at a current time point. Further, second moving body 200 obtains a direction (detected direction 26) of first moving body 100 at a current time point based on an angle between a line connecting midpoints of two reference shapes 21 and a line connecting midpoints of two detected shapes 23. FIG. 7C is a diagram for describing detected position 25 and detected direction 26.

As described above, position calculator 216 compares reference information in a case where first moving body 100 is at a reference position with respect to second moving body 200 with detected shape 23 and detected distance 24 generated based on a newly acquired detection signal, so as to calculate detected position 25 which is a position of first moving body 100 at a current time point and detected direction 26 which is a direction of first moving body 100 at a current time point.

### (Method of Setting Target Point)

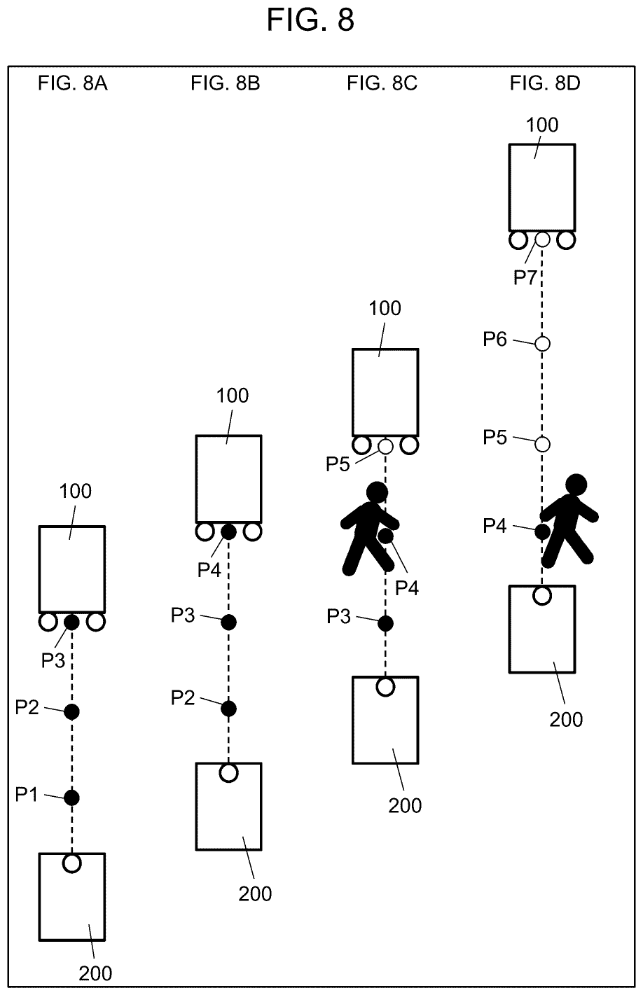

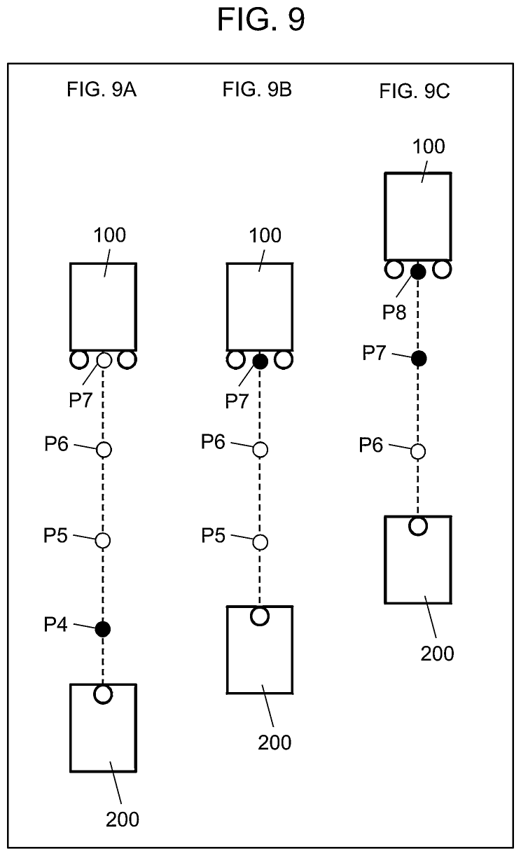

A method of setting a target point by target point setting unit 222 will be described with a specific example. FIGS. 8 and 9 are diagrams for explaining a method of setting a target point. FIGS. 8 and 9 are diagrams of a positional relationship between first moving body 100 and second moving body 200 as viewed from above.

FIG. 8A illustrates a positional relationship between first moving body 100 and second moving body 200 at time point T1. P1 and P2 are detected positions of first moving body 100 at a time point before time point T1. P3 is a detected position of first moving body 100 at time point T1. In FIGS. 8 and 9, a detected position is indicated by a black circle●. At time point T1, second moving body 200 stores detected position information indicating positions of points P1 to P3 in chronological order.

At time point T1, a target point to which second moving body 200 should go is set to P1 which is a closest detected position.

FIG. 8B illustrates a positional relationship between first moving body 100 and second moving body 200 at time point T2 after time point T1. Between time point T1 and time point T2, second moving body 200 passes through point P1. At time point T2, first moving body 100 moves to point P4. Therefore, second moving body 200 further stores detected position information indicating a position of point P4.

At time point T2, a target point to which second moving body 200 should go is set to P2 which is a closest detected position.

FIG. 8C illustrates a positional relationship between first moving body 100 and second moving body 200 at time point T3 after time point T2. FIG. 8C illustrates a state in which person H enters a space between first moving body 100 and second moving body 200 from time point T2 to time point T3. In such a case, since sensor 204 of second moving body 200 cannot receive a reflected wave from reflector 105 of first moving body 100, second moving body 200 loses sight of first moving body 100.

When determining that second moving body 200 is in the state of losing sight, the second moving body 200 estimates a position of first moving body 100 at a current time point (time point T3) based on detected position information immediately before the state of losing sight and displacement information of first moving body 100 after the state of losing sight acquired by wireless communication or the like. In FIG. 8C, point P5 is an estimated position of first moving body 100 at time point T3. In FIGS. 8 and 9, the estimated position is indicated by a white circle. At time point T3, second moving body 200 further stores estimated position information indicating a position of point P5.

At time point T3, a target point to which second moving body 200 should go is set to P3 which is a closest detected position.

FIG. 8D illustrates a positional relationship between first moving body 100 and second moving body 200 at time point T4 after time point T3. Even at time point T4, person H still exists between first moving body 100 and second moving body 200. In this case, for safety, second moving body 200 stops while maintaining a distance not contacting person H. On the other hand, since first moving body 100 continues to move at a previous speed, an inter-vehicle distance from second moving body 200 gradually increases. Second moving body 200 calculates points P6, P7 which are estimated positions of first moving body 100 from time point T3 to time point T4, and further stores estimated position information indicating positions of points P6, P7.

Here, when an inter-vehicle distance between first moving body 100 and second moving body 200 exceeds a predetermined distance, second moving body 200 transmits stop request information for requesting first moving body 100 to stop moving. The predetermined distance is a preset threshold distance, and is a distance obtained by adding a predetermined margin value to a preset inter-vehicle distance between first moving body 100 and second moving body 200. Upon receiving the stop request information, first moving body 100 stops further movement and stops. Assume that first moving body 100 is stopped at point P7.

FIG. 9A illustrates a positional relationship between first moving body 100 and second moving body 200 at time point T5 after time point T4. Assume that person H disappears from between first moving body 100 and second moving body 200 from time point T4 to time point T5. By the above, second moving body 200 can detect a position of first moving body 100. Further, second moving body 200 can start moving.

At time point T5, a target point to which second moving body 200 should go is set to P4 which is a closest detected position.

FIG. 9B illustrates a positional relationship between first moving body 100 and second moving body 200 at time point T6 after time point T5. Between time point T5 and time point T6, second moving body 200 passes through point P4. At time point T6, first moving body 100 remains stopped at point P7. Therefore, an inter-vehicle distance between first moving body 100 and second moving body 200 is shorter than that at time point T5.

When the inter-vehicle distance between first moving body 100 and second moving body 200 becomes within a predetermined distance, second moving body 200 transmits start request information for requesting first moving body 100 to start moving. First moving body 100 that receives the start request information resumes movement.

Note that since first moving body 100 stops moving until time point T6, a detected position of first moving body 100 detected by second moving body 200 at time point T6 should be the same as an estimated position of first moving body 100 estimated by second moving body 200 at time point T5 (point P7). As described above, in a case where a new detected position is substantially the same as a previously estimated position, second moving body 200 may discard the estimated position and newly store only the detected position.

At time point T6, a target point to which second moving body 200 should go is set to P5 which is a closest estimated position.

FIG. 9C illustrates a positional relationship between first moving body 100 and second moving body 200 at time point T7 after time point T6. Between time point T6 and time point T7, second moving body 200 passes through point P5. A detected position of first moving body 100 at time point T7 is point P8. Second moving body 200 further stores detected position information of first moving body 100 at time point T7.

As described above, second moving body 200 stores a detected position or an estimated position of first moving body 100 at each time point in chronological order, and moves to a closest detected position or estimated position at a current time point as a new target point. By the above, second moving body 200 estimates a position where first moving body 100 moves even in the state of losing sight, and moves along the estimated position, so as to be able to move along a path close to a track where first moving body 100 actually moves. Further, after the above, in a case where second moving body 200 can detect first moving body 100 again, it is possible to seamlessly make a transition from movement along an estimated position of first moving body 100 to movement along a detected position of first moving body 100. That is, second moving body 200 can automatically return from the state in which sight of the first moving body is lost to traveling following first moving body 100.

As described above, when an inter-vehicle distance between first moving body 100 and second moving body 200 is a predetermined distance or more for some reason, second moving body 200 transmits stop request information to first moving body 100 to stop first moving body 100. By the above, even in a case where second moving body 200 loses sight of first moving body 100, an inter-vehicle distance from first moving body 100 does not become a predetermined distance or more, and first moving body 100 is easily re-detected after a cause of losing sight is removed.

### Operation Example

Hereinafter, an operation example of moving body system 1 according to the present exemplary embodiment will be described.

### Operation Example 1: Operation of First Moving Body 100

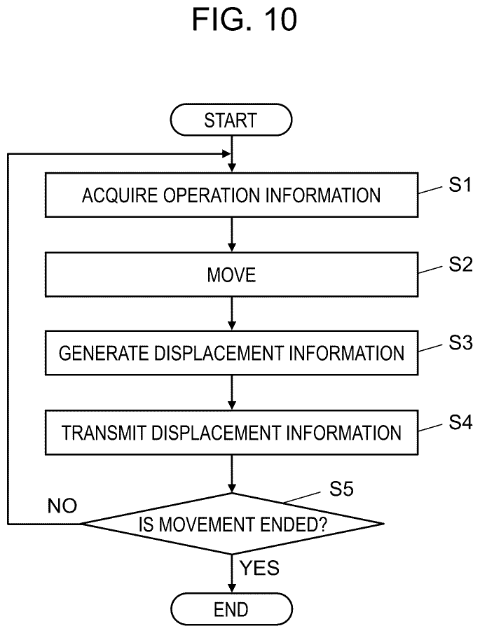

FIG. 10 is a flowchart illustrating an example of operation of first moving body 100. In step S1, first moving body 100 acquires operation information indicating operation content by an operator.

In step S2, first moving body 100 moves according to a moving direction and a speed indicated by the operation information.

In step S3, first moving body 100 generates displacement information indicating a displacement amount due to movement of first moving body 100 (a movement amount and a movement direction of first moving body 100 per unit time).

In step S4, first moving body 100 transmits displacement information of first moving body 100 to second moving body 200.

In step S5, first moving body 100 determines whether or not to end movement. This determination only needs to be made based on, for example, presence or absence of operation for ending movement from an operator. In a case where it is determined to end movement (step S5: YES), first moving body 100 ends operation. Otherwise (step S5: NO), the operation returns to step S1, and step S1 and subsequent steps are repeated.

As described above, first moving body 100 moves according to operation of an operator, and transmits displacement information indicating a displacement amount caused by movement to second moving body 200.

### Operation Example 2: Operation of Second Moving Body 200

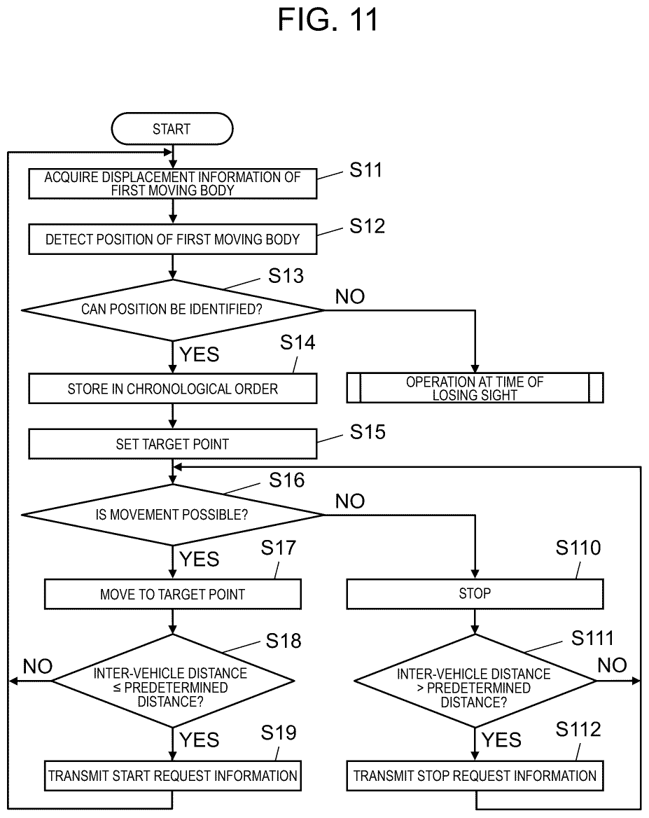

FIG. 11 is a flowchart illustrating an example of operation of second moving body 200. In step S11, second moving body 200 acquires displacement information of first moving body 100 transmitted from first moving body 100.

In step S12, second moving body 200 detects a position of first moving body 100 and generates detection information.

In step S13, second moving body 200 determines whether or not first moving body 100 is detected in step S12. The case where a position of first moving body 100 cannot be detected is, for example, a case where an object such as a person enters a space between first moving body 100 and second moving body 200 as described above. In a case where a position of first moving body 100 can be detected (step S13: YES), second moving body 200 proceeds with the operation to step S15. In a case where a position of first moving body 100 cannot be detected (step S13: NO), second moving body 200 makes a transition to operation at the time of losing sight described later.

Note that, in the example illustrated in FIG. 11, operation shifts to the operation at the time of losing sight in a case where second moving body 200 cannot detect first moving body 100 even once; however, for example, the operation may shift to the operation at the time of losing sight in a case where a situation where second moving body 200 cannot detect first moving body 100 is repeated a predetermined number of times, or in a case where time during which second moving body 200 cannot detect first moving body 100 continues for predetermined time or longer.

Further, in a case where second moving body 200 can detect first moving body 100 in step S13 and a moving speed of second moving body 200 is reduced by the operation at the time of losing sight described later, second moving body 200 returns a moving speed of the second moving body 200 to an original speed.

In step S14, second moving body 200 stores newly acquired displacement information of first moving body 100 and detected position information of first moving body 100 that is detected in chronological order.

In step S15, second moving body 200 sets a next target point of second moving body 200 based on displacement information of second moving body 200 and detected position information of the first moving body 100 stored so far.

In step S16, second moving body 200 determines whether or not movement to the target point is possible. The determination as to whether or not the movement is possible is made, for example, by determining whether or not an obstacle exists on a path to the target point. In a case of determining that the movement is possible (step S16: YES), second moving body 200 proceeds with the operation to step S17. Otherwise (step S16: NO), second moving body 200 proceeds with the operation to step S110.

In a case where it is determined in step S16 that the movement is possible, second moving body 200 executes movement to the target point in step S17.

In step S18, second moving body 200 determines whether or not an inter-vehicle distance to first moving body 100 is less than or equal to a predetermined distance. In a case of determining that the distance is less than or equal to the predetermined distance (step S18: YES), second moving body 200 proceeds with the operation to step S19. Otherwise (step S18: NO), second moving body 200 returns the operation to step S11.

In step S19, second moving body 200 transmits a start request signal for requesting first moving body 100 to start (resume) movement. With such operation, it is possible to prevent a situation in which an inter-vehicle distance between first moving body 100 and second moving body 200 becomes too short. After the above, second moving body 200 returns the operation to step S11.

In a case where it is not determined in step S16 that the movement is possible, in step S110, second moving body 200 stops on the spot.

In step S111, second moving body 200 determines whether or not an inter-vehicle distance to first moving body 100 exceeds a predetermined distance. In a case of determining that the predetermined distance is exceeded (step S111: YES), second moving body 200 proceeds with the operation to step S112. Otherwise (step S111: NO), second moving body 200 returns the operation to step S16.

In step S112, second moving body 200 transmits stop request information for requesting first moving body 100 to stop movement. With such operation, it is possible to prevent a situation in which second moving body 200 cannot detect first moving body 100 because an inter-vehicle distance between first moving body 100 and second moving body 200 further increases. After the above, second moving body 200 returns the operation to step S16.

By the above operation, second moving body 200 can move by accurately following first moving body 100.

### Operation Example 3: Operation at the Time of Losing Sight of Second Moving Body 200

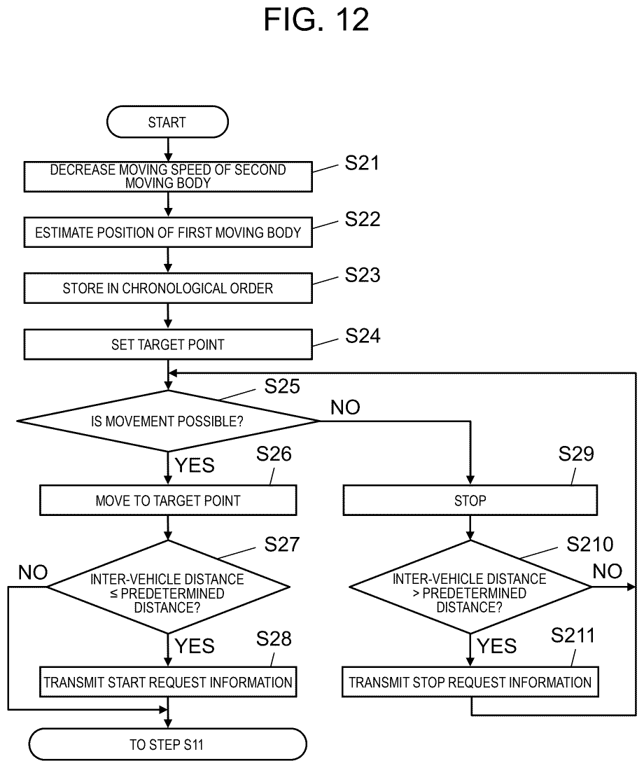

FIG. 12 is a flowchart illustrating an example of operation at the time of losing sight of second moving body 200. In step S21, second moving body 200 decreases a moving speed of second moving body 200 for safety, triggered by the state of losing sight.

In step S22, second moving body 200 estimates a current position of first moving body 100 based on the displacement information of first moving body 100 acquired in step S11 of FIG. 11 and detected position information of first moving body 100 stored so far, and generates estimated position information.

In step S23, second moving body 200 stores the displacement information of first moving body 100 and the estimated position information generated in step S22 in chronological order.

In step S24, second moving body 200 sets a next target point of second moving body 200 based on displacement information of second moving body 200, detected position information of first moving body 100, and estimated position information of first moving body 100 stored so far.

In step S25, second moving body 200 determines whether or not movement to the target point is possible. In a case of determining that the movement is possible (step S25: YES), second moving body 200 proceeds with the operation to step S26. Otherwise (step S25: NO), second moving body 200 proceeds with the operation to step S29.

In a case of determining in step S25 that the movement is possible, second moving body 200 executes movement to the target point in step S26.

In step S27, second moving body 200 determines whether or not an inter-vehicle distance to first moving body 100 is less than or equal to a predetermined distance. In a case of determining that the distance is less than or equal to the predetermined distance (step S27: YES), second moving body 200 proceeds with the operation to step S28. Otherwise (step S27: NO), second moving body 200 returns the operation to step S11 in FIG. 11.

In step S28, second moving body 200 transmits a start request signal for requesting first moving body 100 to start (resume) movement. With such operation, it is possible to prevent a situation in which an inter-vehicle distance between first moving body 100 and second moving body 200 becomes too short. After the above, second moving body 200 returns the operation to step S11 in FIG. 11.

In a case of not determining in step S25 that the movement is possible, in step S29, second moving body 200 second moving body 200 stops on the spot.

In step S210, second moving body 200 determines whether or not an inter-vehicle distance to first moving body 100 exceeds a predetermined distance. In a case of determining that the predetermined distance is exceeded (step S210: YES), second moving body 200 proceeds with the operation to step S211. Otherwise (step S210: NO), second moving body 200 returns the operation to step S25.

In step S211, second moving body 200 transmits stop request information for requesting first moving body 100 to stop movement. With such operation, it is possible to prevent a situation in which second moving body 200 cannot detect first moving body 100 because an inter-vehicle distance between first moving body 100 and second moving body 200 further increases. After the above, second moving body 200 returns the operation to step S25.

With such operation, second moving body 200 estimates a position where first moving body 100 moves even in the state of losing sight, and moves along the estimated position, so as to be able to move along a path close to a track where first moving body 100 actually moves. Further, after the above, in a case where second moving body 200 can detect first moving body 100 again, it is possible to seamlessly make a transition from movement along an estimated position of first moving body 100 to movement along a detected position of first moving body 100. That is, second moving body 200 can automatically return from the state in which sight of the first moving body is lost to traveling following first moving body 100.

### <Variation>

In the above-described exemplary embodiment, moving body system 1 includes preceding first moving body 100 and following second moving body 200. The moving body system of the present disclosure may include three or more moving bodies, and these moving bodies may travel in formation. In this case, a moving body at the head of a formation has the same configuration as first moving body 100 in the above-described exemplary embodiment, and only needs to perform the same operation. Following moving bodies other than a rearmost moving body only need to have a configuration in which reflector 105 of first moving body 100 is added to second moving body 200 in the above-described exemplary embodiment. Instead of following first moving body 100, a following moving body only needs to travel following a moving body traveling immediately before.

### INDUSTRIAL APPLICABILITY

The present disclosure is useful for a moving body system including a preceding moving body and a moving body that follows the preceding moving body.

### REFERENCE MARKS IN THE DRAWINGS

1: moving body system
100: first moving body
101: main body
102, 102a, 102b: wheel
103: trailing wheel
105: reflector
106a, 106b: sensing ring
107, 107a, 107b: encoder
108: gyro
109: drive unit
110: controller
111: counter unit
112: angle calculator
113: displacement calculator
114: transmitter
115: receiver
120: operation controller
121: drive controller
200: second moving body
201: main body
202, 202a, 202b: wheel
203: trailing wheel
204: sensor
206a, 206b: sensing ring
207, 207a, 207b: encoder
208: gyro
209: drive unit
210: controller
211: counter unit
212: angle calculator
213: displacement calculator
214: transmitter
215: receiver
216: position calculator
217: determination unit
218: estimation unit
219: storage unit
220: operation controller
221: drive controller
222: target point setting unit
223: distance calculator

1. A moving body that follows a preceding moving body, the moving body comprising:
a position calculator that identifies a position of the preceding moving body based on an output value from a sensor that acquires information around the moving body;
a receiver that receives displacement information indicating a displacement amount of a position of the preceding moving body due to movement of the preceding moving body; and
an operation controller that performs control to move the moving body based on an identified position of the preceding moving body and the displacement information in a state of losing sight in which the position calculator cannot identify a position of the preceding moving body.

2. The moving body according to claim 1, further comprising an estimation unit that estimates, in the state of losing sight, a current position of the preceding moving body based on a position of the preceding moving body that is last identified by the position calculator and the displacement information from a time point at which a position of the preceding moving body is last identified to a current time point.

3. The moving body according to claim 2, further comprising a target point setting unit that sets a target point to which the moving body is moved based on a position identified by the position calculator or a position estimated by the estimation unit in the state of losing sight,
wherein the operation controller performs control to move the moving body toward the target point.

4. The moving body according to claim 3, further comprising a distance calculator that calculates a distance between the moving body and the preceding moving body at a current time point based on a position identified by the position calculator or a position estimated by the estimation unit, and generates stop request information for requesting the preceding moving body to stop moving based on the distance.

5. The moving body according to claim 1, wherein the state of losing sight is a state where the position calculator does not identify a position of the preceding moving body, the state continuing for predetermined time.

6. The moving body according to claim 1, wherein the operation controller performs control to reduce a speed of the moving body and move the moving body when transition is made to the state of losing sight.

7. A moving body system comprising:
a preceding first moving body; and
a second moving body that follows the first moving body,
wherein the first moving body transmits displacement information indicating a displacement amount of a position of the first moving body per unit time to the second moving body, and
the second moving body includes:
a position calculator that identifies a position of the first moving body based on an output value from a sensor that acquires information around the second moving body;
a receiver that receives the displacement information from the first moving body; and
an operation controller that performs control to move the first moving body based on an identified position of the first moving body and the displacement information in a state of losing sight where the position calculator cannot identify a position of the first moving body.
